(19) United States
(12) Patent Application Publication
(10) Pub. No.: US 2017/0155294 A1
(43) Pub. Date: Jun. 1, 2017

(54) INTERIOR PERMANENT MAGNET MOTOR WITH FLUX STRENGTHENING

(71) Applicant: NEW WIDETECH INDUSTRIES CO., LTD., New Taipei City (TW)

(72) Inventor: Ming-Tsung Chiu, New Taipei City (TW)

(21) Appl. No.: 14/952,993

(22) Filed: Nov. 26, 2015

(51) Int. Cl. H02K 1/27; H02K 1/02

(52) U.S. Cl. CPC H02K 1/2773; H02K 1/02

(57) ABSTRACT

An interior permanent magnet motor with flux strengthening includes a stator and a rotor. The stator has a mounting hole centrally formed through the stator and multiple stator teeth circumferentially formed on an inner portion of the stator between a periphery of the stator and the mounting hole. The rotor is rotatably mounted inside the mounting hole and includes multiple permanent magnets circumferentially and axially mounted inside the rotor. Each permanent magnet has two radial sides. The rotor further includes multiple flux barrier grooves. Each flux barrier groove is axially formed through a portion of the rotor located beside one of the two radial sides of a corresponding permanent magnet. The presence of the flux barrier grooves serves to shield and guide the lines of magnetic flux of the permanent magnets so as to concentrate the lines of magnetic flux, strengthen flux linkage, and reduce flux leakage.

### BACKGROUND OF THE INVENTION

1. Field of the Invention

The present invention relates to a permanent magnet motor and, more particularly, to an interior permanent magnet motor with flux strengthening.

2. Description of the Related Art

With reference to FIG. 10, all current air-conditioning compressors are equipped with a conventional motor 30 for attaining the purpose of conditioning air through operation of the motor. The conventional motor 30 includes a rotor 31 and a stator 32. There are six permanent magnets 311 annularly mounted around an inner wall of the rotor 31 and spaced apart from each other by gaps. The polarities of any adjacent two of the six permanent magnets 311 are reversed. The stator 32 has multiple stator teeth 321 with a coil mounted around each stator tooth 321. When current flows through the coils, each stator tooth 321 generates corresponding polarities according to the direction of current flow and attraction force and repulsion force acting on the permanent magnets 311 force the rotor 31 to rotate and the motor 30 starts running.

When the current flowing through the coils is fixed, the torque out of rotation of the motor is directly proportional to the magnetic force of the permanent magnets 311. Higher torque usually ensures a better operation performance of the motor 30. However, the permanent magnets 311 with higher magnetic force also come with a higher production cost, inevitably increasing the total production cost of the motor 30.

### SUMMARY OF THE INVENTION

An objective of the present invention is to provide an interior permanent magnet motor with flux strengthening capable of getting rid of the use of power magnets and thus lowering production cost with regular permanent magnets.

To achieve the foregoing objective, the interior permanent magnet motor with flux strengthening includes a stator and a rotor.

The stator is cylindrical and has a mounting hole and multiple stator teeth.

The mounting hole is centrally and axially formed through the rotor.

The multiple stator teeth are circumferentially and axially formed on and protrude radially and inwardly from an inner portion of the stator between a periphery of the stator and the mounting hole.

The rotor is rotatably mounted inside the mounting hole of the stator and has multiple permanent magnets and multiple flux barrier grooves.

The multiple permanent magnets are circumferentially and axially mounted inside the rotor and are spaced apart from each other. Each permanent magnet has two radial sides, a centripetal end and a centrifugal end.

The two radial sides are formed on the permanent magnet, are opposite to each other, and align radially. The two radial sides of each permanent magnet respectively have two different polarities and the polarities of the neighboring radial sides of any adjacent two of the multiple permanent magnets are identical.

The centrifugal end is opposite to the centripetal end.

Each flux barrier groove is axially formed through a portion of the rotor located beside one of the two radial sides of a corresponding permanent magnet.

Because the coefficient of magnetic permeability of a body of the rotor is higher than those of the flux barrier grooves and the short flux barrier grooves, the lines of magnetic flux of each permanent magnet are prioritized to pass through the body of the rotor. The multiple flux barrier grooves and the multiple short flux barrier grooves are dedicated to shield and guide the lines of magnetic flux of the multiple permanent magnets, thereby concentrating the lines of magnetic flux of the multiple permanent magnets to strengthen flux linkage and reduce flux leakage of the multiple permanent magnets. Accordingly, even magnets in a motor with weak magnetic force can be utilized in collaboration with the foregoing design for strengthening magnetic flux density to provide stronger rotation torque and enhanced operation efficacy of the motor.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an interior permanent magnet motor with flux strengthening in accordance with the present invention;

FIG. 2 is a front view of the interior permanent magnet motor in FIG. 1;

FIG. 3 is a schematic view showing a distribution of lines of magnetic flux of the interior permanent magnet motor in FIG. 1;

FIG. 4 is a front view of a second embodiment of an interior permanent magnet motor with flux strengthening in accordance with the present invention;

FIG. 5 is a schematic view showing a distribution of lines of magnetic flux of the interior permanent magnet motor in FIG. 4;

FIG. 6 is a front view of a third embodiment of an interior permanent magnet motor with flux strengthening in accordance with the present invention;

FIG. 7 is a schematic view showing a distribution of lines of magnetic flux of the interior permanent magnet motor in FIG. 6;

FIG. 8 is a front view of a fourth embodiment of an interior permanent magnet motor with flux strengthening in accordance with the present invention;

FIG. 9 is a schematic view showing a distribution of lines of magnetic flux of the interior permanent magnet motor in FIG. 8; and

FIG. 10 is a schematic view showing a distribution of lines of magnetic flux of a conventional motor.

### DETAILED DESCRIPTION OF THE INVENTION

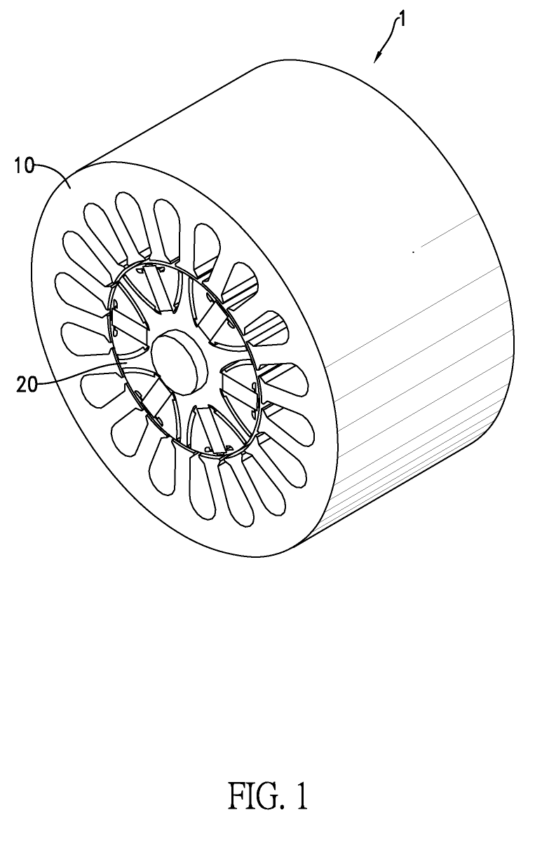

With reference to FIG. 1, a first embodiment of an interior permanent magnet motor with flux strengthening 1 in accordance with the present invention includes a stator 10 and a rotor 20.

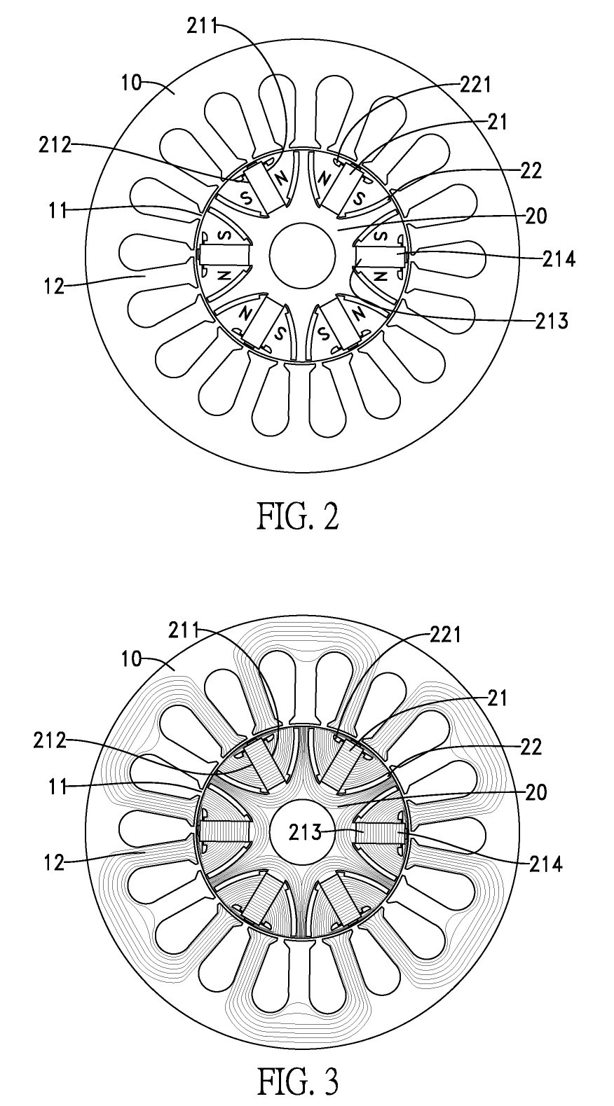

With reference to FIG. 2, the stator 10 in FIG. 1 is cylindrical and has a mounting hole 11 and multiple stator teeth 12. The mounting hole 11 is centrally and axially formed through the stator 10. The multiple stator teeth 12 are circumferentially and axially formed on and protrude radially and inwardly from an inner portion of the stator 10 between a periphery and the mounting hole 11 of the stator 10 and are spaced apart from each other. Each stator tooth 12 has a coil mounted around a periphery of the stator tooth 12.

The rotor 20 is cylindrical, is rotatably mounted inside the mounting hole 11 of the stator 10, and has multiple permanent magnets 21, multiple flux barrier grooves 22 and multiple short flux barrier grooves 221. The multiple permanent magnets 21 take the form of a cuboid, are circumferentially and axially mounted inside the rotor 20, and are spaced apart from each other. Each permanent magnet 21 has two radial sides 211, 212 formed thereon, being opposite to each other, and aligning radially. The two radial sides 211, 212 of each permanent magnet 21 have two different polarities respectively. The polarities of the neighboring radial sides of any adjacent two of the multiple permanent magnets 21 are identical.

Each flux barrier groove 22 and an adjacent one of the multiple short flux barrier grooves 221 are axially formed through a portion of the rotor 20 located beside one of the two radial sides of a corresponding permanent magnet 21. In the present embodiment, there are six permanent magnets 21, twelve flux barrier grooves 22 and twelve short flux barrier grooves 221. One flux barrier groove 22 and one short flux barrier groove 221 are axially formed in a portion of the rotor 20 beside each radial side of each permanent magnet 21. Each permanent magnet 21 further has a centripetal end 213 and a centrifugal end 214 opposite to the centripetal end 213. Each flux barrier groove 22 takes a curved form and extends between the centripetal end 214 of a corresponding permanent magnet 21 and an outer wall of the rotor 20, and a concaved portion of the flux barrier groove 22 faces the corresponding permanent magnet 21. Each short flux barrier groove 221 is formed through a portion of the rotor 20 adjacent to the centrifugal end 214 of a corresponding permanent magnet 21 and extends in a circumferential direction consistent with a direction of the lines of magnetic flux of the corresponding permanent magnet 21.

With reference to FIGS. 2 and 3, as the coefficient of magnetic permeability of a body of the rotor 20 is higher than those of the flux barrier grooves 22 and the short flux barrier grooves 221, the lines of magnetic flux of each permanent magnet 21 are prioritized to pass through the body of the rotor 20. The presence of the multiple flux barrier grooves 22 and the multiple short flux barrier grooves 221 serves to shield and guide the lines of magnetic flux of the multiple permanent magnets 21, such that the lines of magnetic flux of the multiple permanent magnets 21 can be concentrated to strengthen flux linkage and reduce flux leakage of the multiple permanent magnets 21. In that sense, even magnets in a motor with weak magnetic force can be utilized in collaboration with the foregoing design for strengthening magnetic flux density to provide stronger rotation torque and enhanced operation efficacy of the motor.

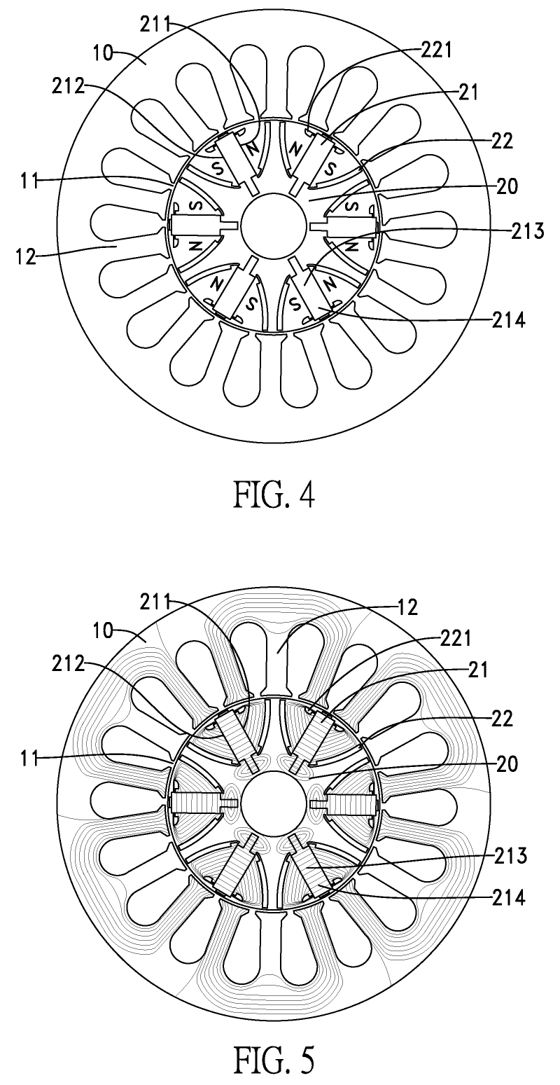

With reference to FIGS. 4 and 5, a second embodiment of an interior permanent magnet motor with flux strengthening 1 in accordance with the present invention differs from the first embodiment in that a cross-section of the centripetal end 213 of each permanent magnet 21 is smaller than that of the centrifugal end 214 of the permanent magnet 21. The reduced cross-section of the centripetal end 213 of each permanent magnet 21 alters how the lines of magnetic flux of the permanent magnet 21 go and effectively improves flux leakage of the rotor 20 as illustrated in FIG. 5.

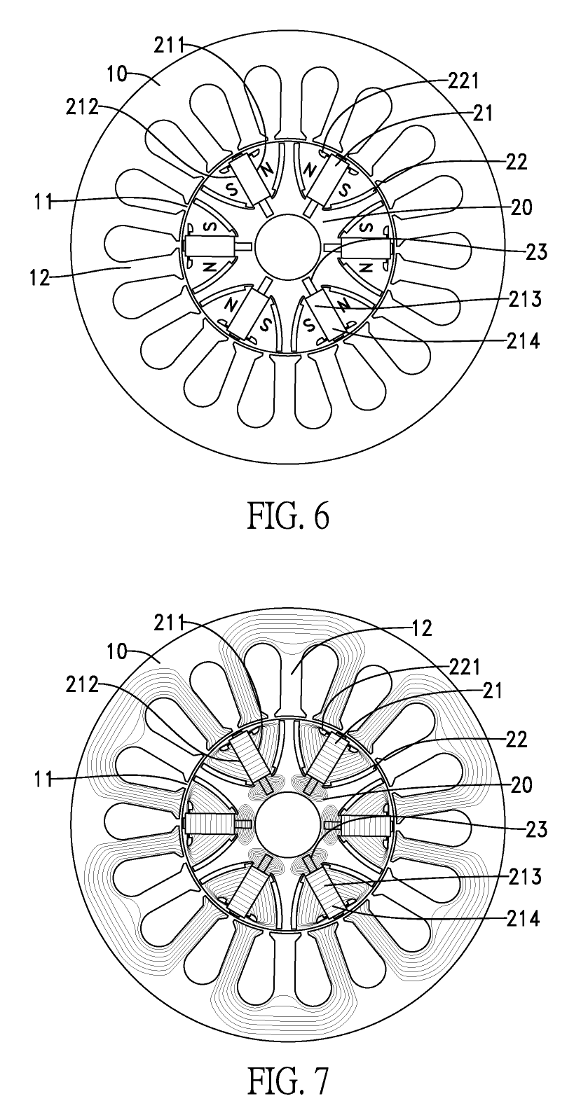

With reference to FIGS. 6 and 7, a third embodiment of an interior permanent magnet motor with flux strengthening 1 in accordance with the present invention differs from the first embodiment in that the centripetal end 213 of each permanent magnet 21 is connected with a power magnet 23 having polarities identical to those of the connected permanent magnet 21. The presence of the power magnets 23 serves to alter how the lines of magnetic flux of the multiple permanent magnets 21 go and effectively improves flux leakage of the rotor 20 as illustrated in FIG. 7. In the present embodiment, the power magnets 23 are made from neodymium iron boron (NdFeB).

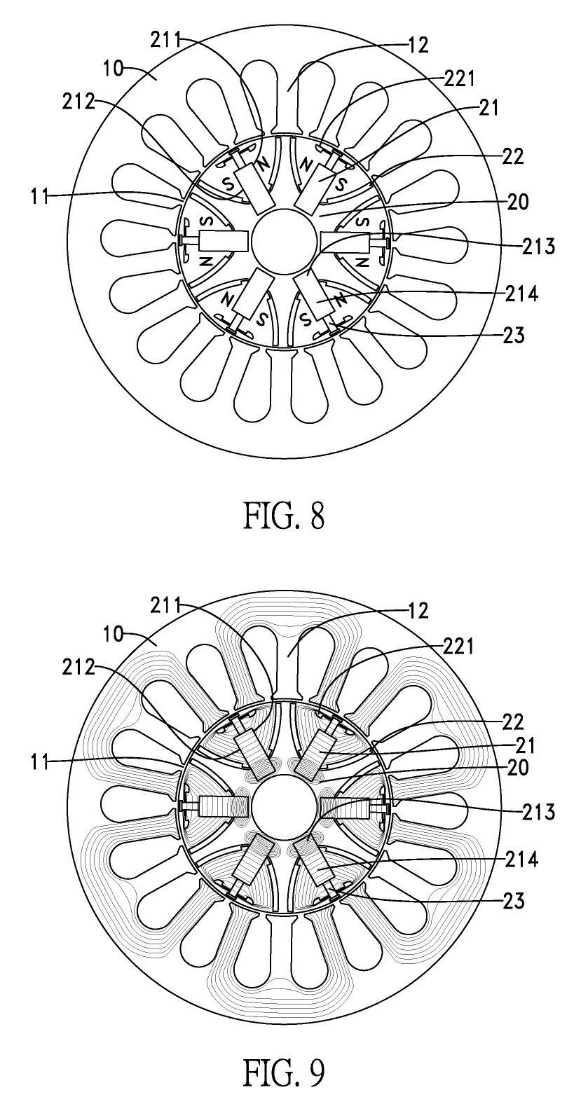

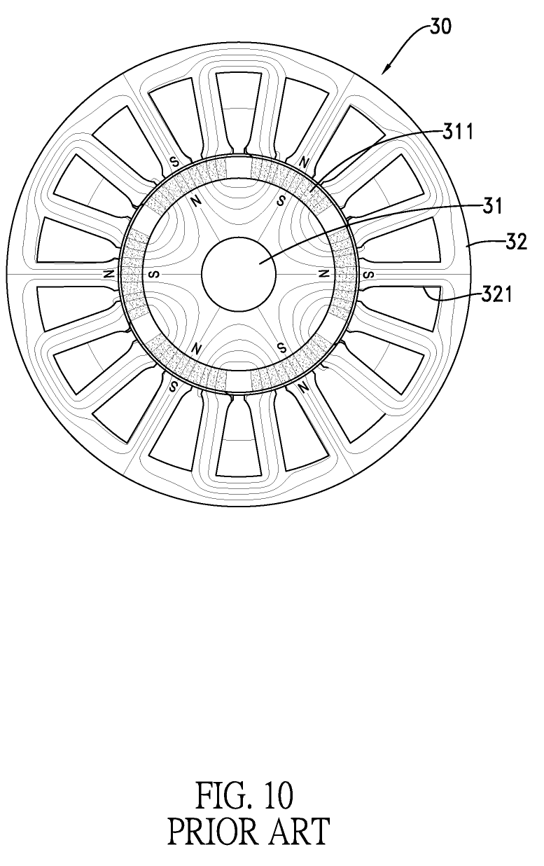

With reference to FIGS. 8 and 9, a fourth embodiment of an interior permanent magnet motor with flux strengthening 1 in accordance with the present invention differs from the first embodiment in that the centrifugal end 214 of each permanent magnet 21 is connected with a power magnet 23 having polarities identical to those of the connected permanent magnet 21. The presence of the power magnets 23 serves to alter how the lines of magnetic flux of the multiple permanent magnets 21 go and effectively improves flux leakage of the rotor 20 as illustrated in FIG. 9. In the present embodiment, the power magnets 23 are made from neodymium iron boron (NdFeB).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An interior permanent magnet motor with flux strengthening, comprising:
a stator being cylindrical and having:
a mounting hole centrally and axially formed through the rotor; and
multiple stator teeth circumferentially and axially formed on and protruding radially and inwardly from an inner portion of the stator between a periphery of the stator and the mounting hole; and
a rotor rotatably mounted inside the mounting hole of the stator, and having:
multiple permanent magnets circumferentially and axially mounted inside the rotor and spaced apart from each other, each permanent magnet having:
two radial sides formed thereon, being opposite to each other, and aligning radially, wherein the two radial sides of each permanent magnet respectively have two different polarities and the polarities of the neighboring radial sides of any adjacent two of the multiple permanent magnets are identical;
a centripetal end; and
a centrifugal end opposite to the centripetal end; and
multiple flux barrier grooves, each flux barrier groove axially formed through a portion of the rotor located beside one of the two radial sides of a corresponding permanent magnet.

2. The interior permanent magnet motor as claimed in claim 1, further comprising six permanent magnets and twelve flux barrier grooves.

3. The interior permanent magnet motor as claimed in claim 1, wherein each flux barrier groove takes a curved form and extends between the centripetal end of a corresponding permanent magnet and an outer wall of the rotor.

4. The interior permanent magnet motor as claimed in claim 2, wherein each flux barrier groove takes a curved form and extends between the centripetal end of a corresponding permanent magnet and an outer wall of the rotor.

5. The interior permanent magnet motor as claimed in claim 1, further comprising six permanent magnets, twelve flux barrier grooves, and twelve short flux barrier grooves, wherein each short flux barrier groove is formed through a portion of the rotor adjacent to the centrifugal end of a corresponding permanent magnet.

6. The interior permanent magnet motor as claimed in claim 5, wherein
each flux barrier groove takes a curved form and extends between the centripetal end of a corresponding permanent magnet and an outer wall of the rotor; and
each short flux barrier groove extends in a circumferential direction.

7. The interior permanent magnet motor as claimed in claim 1, wherein a cross-section of the centripetal end of each permanent magnet is smaller than a cross-section of the centrifugal end of the permanent magnet.

8. The interior permanent magnet motor as claimed in claim 5, wherein a cross-section of the centripetal end of each permanent magnet is smaller than a cross-section of the centrifugal end of the permanent magnet.

9. The interior permanent magnet motor as claimed in claim 6, wherein a cross-section of the centripetal end of each permanent magnet is smaller than a cross-section of the centrifugal end of the permanent magnet.

10. The interior permanent magnet motor as claimed in claim 1, wherein the centripetal end of each permanent magnet is connected with a power magnet having polarities identical to those of the connected permanent magnet.

11. The interior permanent magnet motor as claimed in claim 5, wherein the centripetal end of each permanent magnet is connected with a power magnet having polarities identical to those of the connected permanent magnet.

12. The interior permanent magnet motor as claimed in claim 6, wherein the centripetal end of each permanent magnet is connected with a power magnet having polarities identical to those of the connected permanent magnet.

13. The interior permanent magnet motor as claimed in claim 10, wherein the power magnets are made from neodymium iron boron (NdFeB).

14. The interior permanent magnet motor as claimed in claim 11, wherein the power magnets are made from NdFeB.

15. The interior permanent magnet motor as claimed in claim 12, wherein the power magnets are made from NdFeB.

16. The interior permanent magnet motor as claimed in claim 1, wherein the centrifugal end of each permanent magnet is connected with a power magnet having polarities identical to those of the connected permanent magnet.

17. The interior permanent magnet motor as claimed in claim 5, wherein the centrifugal end of each permanent magnet is connected with a power magnet having polarities identical to those of the connected permanent magnet.

18. The interior permanent magnet motor as claimed in claim 6, wherein the centrifugal end of each permanent magnet is connected with a power magnet having polarities identical to those of the connected permanent magnet.
